(19) United States
(12) Patent Application Publication
(10) Pub. No.: US 2017/0065888 A1
(43) Pub. Date: Mar. 9, 2017

(54) Identifying And Extracting Video Game Highlights

(71) Applicant: SRI International, Menlo Park, CA (US)

(72) Inventor: Hui Cheng, Bridgewater, NJ (US)

(21) Appl. No.: 14/984,999

(22) Filed: Dec. 30, 2015

Related U.S. Application Data
(60) Provisional application No. 62/214,633, filed on Sep. 4, 2015.

(51) Int. Cl. A63F 13/497

(52) U.S. Cl. CPC A63F 13/497; A63F 2300/634

(57) ABSTRACT

The present invention extends to methods, systems, and computer program products for identifying and extracting game video highlights. Game highlights are identified and extracted from game video recorded or streamed from video games. Game highlights are created by identifying low-level features in a game video. Then, game concepts are detected based on identified low-level features. A game concept space is created for different types of game concepts. One or more highlights are generated using the concept space based on game knowledge and/or user preference. Multiple highlights can be fused together into a compilation of highlights.

### CROSS-REFERENCE TO RELATED APPLICATIONS

This application claims priority to and the benefit of U.S. Provisional Application Ser. No. 62/214,633, filed Sep. 4, 2015, which is incorporated herein by this reference in its entirety.

### FIELD OF THE INVENTION

Embodiments of this invention relate to the creation of highlights of game videos of video games. More particularly, embodiments of this invention relate to the automated creation of video highlights for sharing, searching and storage.

### BACKGROUND OF THE INVENTION

The video game industry is of increasing commercial importance, with growth driven particularly by the emerging markets and mobile games. As of 2015, video games generated sales of around USD 74 billion annually worldwide, and were the third-largest segment in the U.S. entertainment market, behind broadcast and cable TV.

A video game is an electronic game that involves human interaction using an interface to generate visual feedback at a video device such as a television screen or computer monitor and possibly also generate audible feedback on at audio device such as a speaker. Video games are typically computer programs that can run on different computing platforms, such as, personal computers, mobile phones, gaming consoles (e.g., Playstation™, an Xbox One™, etc.), or similar devices. Most computing platforms include some recording mechanism to record video game gameplay, including both visual and audible feedback. When video game gameplay is recorded, the stored recording may be referred to as a game video.

Game videos may have events or activities of high interest or of little or no interest. Activities of high interest to a user or groups of users may be referred to as highlights of the game video. Such highlights may be shared among users and/or may have promotional value to a video game developer or retailer. However, extracting highlights from game videos is often time consuming and is typically accomplished using a manual process that includes viewing the game videos and individually tagging highlights. Tagging, such as naming an event, may also be inconsistent if a naming process is not well defined and/or has variations that are evaluator dependent. As such, identifying and extracting highlights from game videos is typically a somewhat ad hoc process with little or no uniformity.

### BRIEF DESCRIPTION OF THE DRAWINGS

This disclosure is illustrated by way of example and not by way of limitation in the accompanying figures. The figures may, alone or in combination, illustrate one or more embodiments of the disclosure. Elements illustrated in the figures are not necessarily drawn to scale. Reference labels may be repeated among the figures to indicate corresponding or analogous elements.

FIG. 1 illustrates an example block diagram of a computing device.

FIG. 2 illustrates an example computer architecture that facilitates identifying and extracting video game highlights.

FIG. 3 illustrates a flow chart of an example method for identifying and extracting video game highlights.

FIG. 4 illustrates an example computer architecture that facilitates identifying and extracting video game highlights.

FIG. 5 illustrates a flow chart of an example method for identifying and extracting video game highlights.

FIG. 6 illustrates an exemplary architecture that facilitates creating video game highlights based on concept ontology.

### DETAILED DESCRIPTION

The present invention relates to methods, systems, and computer program products for identifying and extracting highlights of video games. Aspects of the invention are based on automatic game concept detection and relevant game ontology. Aspects build multiple game related concept detectors using machine learning technologies. The concept detectors are applied to a game video (e.g., recorded or streaming visual and audible feedback from a video game) to detect relevant concepts, for example, based on a user's preferences. Video segments with higher importance can be selected and combined to create highlights of the game video. A user also has the option to edit the highlights such that highlights may correspond more closely to the user's need.

In one aspect, game highlights of a game video are generated, for example, using computer vision technologies. Low-level features present in the game video of are identified by applying feature detection algorithms for detecting multiple feature types. The feature types can include one or more of scenes, characters, actions, objects, texts, audio, items defined by the video game, and descriptions. Game concepts are detected based on the low-level features and knowledge of spatial/temporal relationships of the video game. A game concept space is created by establishing concept types of game concepts of high interest. One or more highlights are generated based on the concept types along with user preferences.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media (devices). Computer-readable media that carry computer-executable instructions are transmission media. Thus, by way of example, and not limitation, embodiments of the invention can comprise at least two distinctly different kinds of computer-readable media: computer storage media (devices) and transmission media.

Computer storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. RAM can also include solid state drives (SSDs or PCIx based real time memory tiered Storage, such as FusionIO). Thus, it should be understood that computer storage media (devices) can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, various storage devices, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the invention can also be implemented in cloud computing environments. In this description and the following claims, “cloud computing” is defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction, and then scaled accordingly. A cloud model can be composed of various characteristics (e.g., on-demand self-service, broad network access, resource pooling, rapid elasticity, measured service, etc.), service models (e.g., Software as a Service (SaaS), Platform as a Service (PaaS), Infrastructure as a Service (IaaS), and deployment models (e.g., private cloud, community cloud, public cloud, hybrid cloud, etc.). Databases and servers described with respect to the present invention can be included in a cloud model.

Further, where appropriate, functions described herein can be performed in one or more of: hardware, software, firmware, digital components, or analog components. For example, one or more application specific integrated circuits (ASICs) can be programmed to carry out one or more of the systems and procedures described herein. Certain terms are used throughout the following description and Claims to refer to particular system components. As one skilled in the art will appreciate, components may be referred to by different names. This document does not intend to distinguish between components that differ in name, but not function.

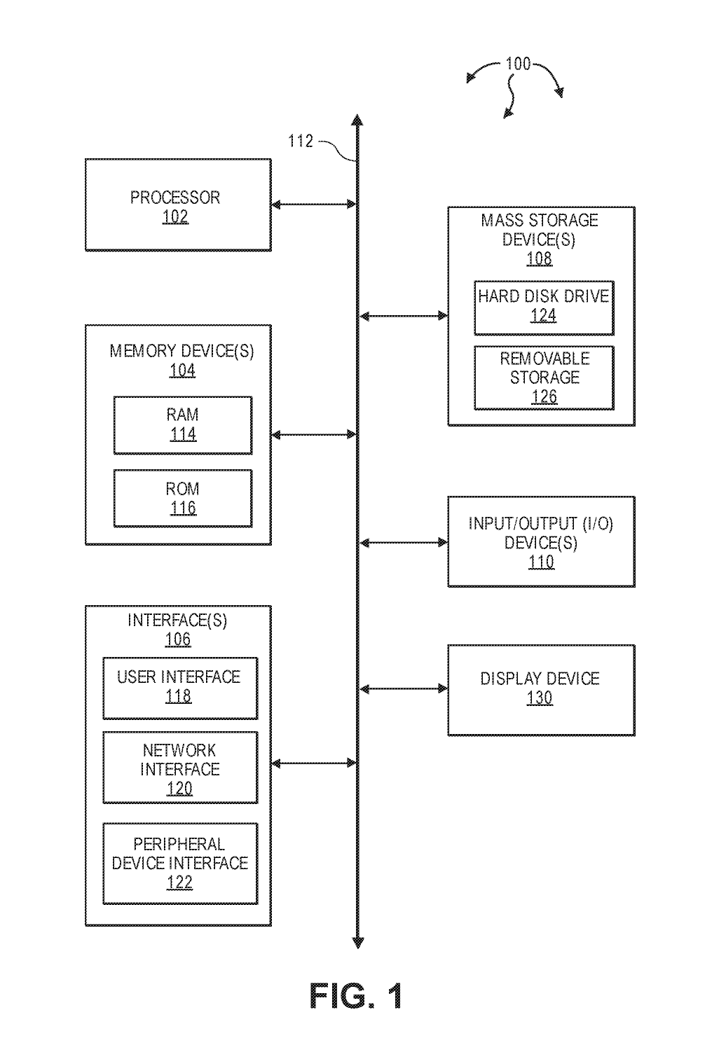

FIG. 1 illustrates an example block diagram of a computing device 100. Computing device 100 can be used to perform various procedures, such as those discussed herein. Computing device 100 can function as a server, a client, or any other computing entity. Computing device 100 can perform various communication and data transfer functions as described herein and can execute one or more application programs, such as the application programs described herein. Computing device 100 can be any of a wide variety of computing devices, such as a mobile telephone or other mobile device, a desktop computer, a notebook computer, a server computer, a handheld computer, tablet computer and the like.

Computing device 100 includes one or more processor(s) 102, one or more memory device(s) 104, one or more interface(s) 106, one or more mass storage device(s) 108, one or more Input/Output (I/O) device(s) 110, and a display device 130 all of which are coupled to a bus 112. Processor(s) 102 include one or more processors or controllers that execute instructions stored in memory device(s) 104 and/or mass storage device(s) 108. Processor(s) 102 may also include various types of computer storage media, such as cache memory.

Memory device(s) 104 include various computer storage media, such as volatile memory (e.g., random access memory (RAM) 114) and/or nonvolatile memory (e.g., read-only memory (ROM) 116). Memory device(s) 104 may also include rewritable ROM, such as Flash memory.

Mass storage device(s) 108 include various computer storage media, such as magnetic tapes, magnetic disks, optical disks, solid state memory (e.g., Flash memory), and so forth. As depicted in FIG. 1, a particular mass storage device is a hard disk drive 124. Various drives may also be included in mass storage device(s) 108 to enable reading from and/or writing to the various computer readable media. Mass storage device(s) 108 include removable media 126 and/or non-removable media.

I/O device(s) 110 include various devices that allow data and/or other information to be input to or retrieved from computing device 100. Example I/O device(s) 110 include cursor control devices, keyboards, keypads, barcode scanners, microphones, monitors or other display devices, speakers, printers, network interface cards, modems, cameras, lenses, CCDs or other image capture devices, and the like.

Display device 130 includes any type of device capable of displaying information to one or more users of computing device 100. Examples of display device 130 include a monitor, display terminal, video projection device, and the like.

Interface(s) 106 include various interfaces that allow computing device 100 to interact with other systems, devices, or computing environments as well as humans. Example interface(s) 106 can include any number of different network interfaces 120, such as interfaces to personal area networks (PANs), local area networks (LANs), wide area networks (WANs), wireless networks (e.g., near field communication (NFC), Bluetooth, Wi-Fi, etc, networks), and the Internet. Other interfaces include user interface 118 and peripheral device interface 122.

Bus 112 allows processor(s) 102, memory device(s) 104, interface(s) 106, mass storage device(s) 108, and I/O device(s) 110 to communicate with one another, as well as other devices or components coupled to bus 112. Bus 112 represents one or more of several types of bus structures, such as a system bus, PCI bus, IEEE 1394 bus, USB bus, and so forth.

Within this description and following claims, a “game video” is defined as a recording of visual feedback and/or audible feedback from one or more users playing and/or one or more users observing the play of a video game. In one aspect, a game video is a session recording of a user playing a video game on a personal computer, mobile device, gaming console, or other computing device. In another aspect, a game video is a recording of multiple users playing a video game, such as, for example, a game in which multiple teams of users (and possible also an audience (observers)) is participating. In this other aspect, each of the multiple users can be using a personal computer, mobile device, gaming console, or other computing device.

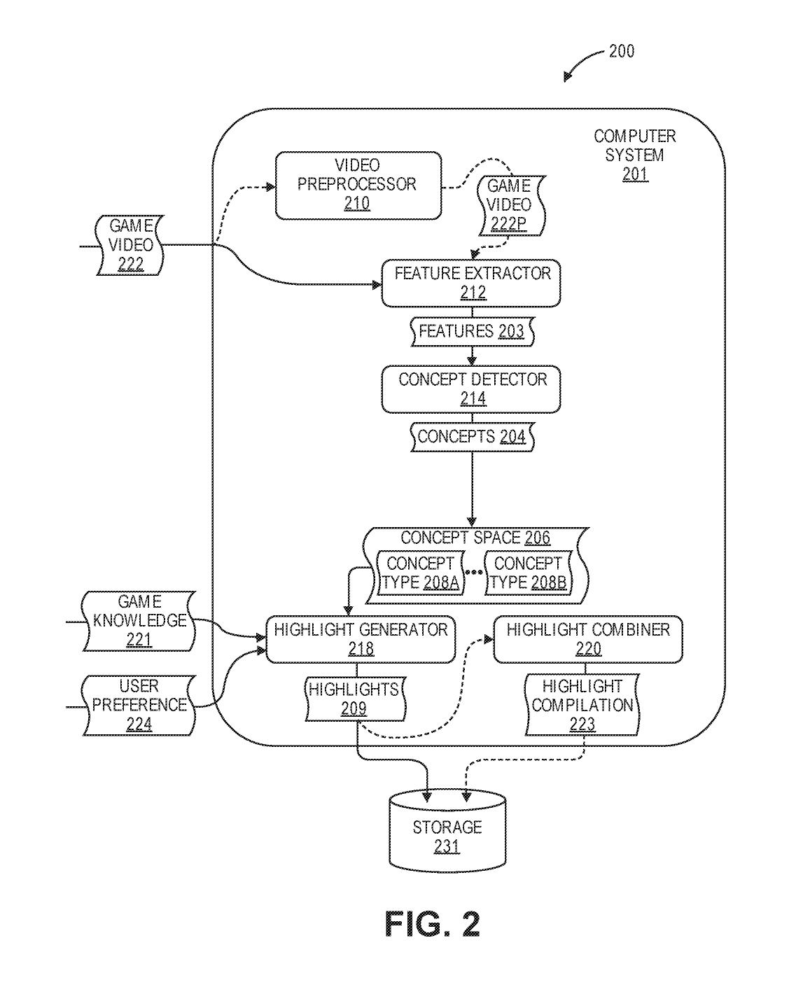

FIG. 2 illustrates an example computer architecture 200 that facilitates identifying and extracting video game highlights. As depicted, computer architecture 200 includes computer system 201. Generally, computer system 201 can include modules that, using a processor (e.g., processor 102), process game video into one or more highlights. In one aspect, game video is accessed from a storage device, such as, hard disk drive 124 or removable storage 126. A user may request highlights through an I/O device (e.g., from among I/O devices 110). In response, the modules of computer system 201 access game video form the storage device. The modules of computer system 201 process the accessed game video to identify and extract one or more highlights from the game video.

More specifically, as depicted in computer architecture 200, computer system 201 includes video preprocessor 210, feature extractor 212, concept detector 214, highlight generator 218, and highlight combiner 220.

In general, video preprocessor 210 is configured to pre-process a game video into a form that is compatible with other modules used for highlight identification and extraction. Pre-processing can include one or more of: decompressing compressed video, enhancing video quality, computing shots and scene cuts, and extracting key frames.

Feature extractor 212 is configured to identify and extract low-level features in a game video. In general, low-level features may include atomic actions and atomic elements or combinations thereof. Game video and/or audio can be used to enhance low-level feature identification and extraction. Low-level features can include: visual features, audible features, automated speech recognition results, and optical character recognition results. Visual features can include: appearance features, such as, feature points, texture descriptors, color histograms, neural network features, and motion features. Motion features can include: trajectory features, motion layers, and optical flow descriptors.

Feature extractor 212 can use any of a variety of detection algorithms to detect features of a game video. Detection algorithms for detecting visual features can include static feature detectors, such as, Gist, SIFT (Scale-Invariant Feature Transform), and colorSIFT. For example, a Gist feature detector can be used to detect abstract scene and layout information, including perceptual dimensions such as naturalness, openness, roughness, and similar characteristics. A SIFT feature detector can be used to detect the appearance of an image at particular interest points without regard to image scale, rotation, level of illumination, noise, and minor changes in viewpoint. A colorSIFT feature detector extends the SIFT feature detector to include color key points and color descriptors, such as intensity, shadow, and shading effects.

Detection algorithms for detecting visual features can also include dynamic feature detectors, such as, MoSIFT, STIP (Spatio-Temporal Interest Point), DTFHOG (Dense Trajectory based Histograms of Oriented Gradients), and DTF-MBH (Dense-Trajectory based Motion Boundary Histogram). Dynamic feature detectors can detect dynamic visual features, including visual features that are computed over x-y-t segments or windows of a game video. Dynamic feature detectors can detect the appearance of characters, objects and scenes as well as their motion information.

A MoSIFT feature detector extends a SIFT feature detector to the time dimension and can collect both local appearance and local motion information. The MoSIFT feature detector can identify interest points in the video that contain at least a minimal amount of movement. A STIP feature detector computes a spatio-temporal second-moment matrix at each video point using independent spatial and temporal scale values, a separable Gaussian smoothing function, and space-time gradients. A DTF-HoG feature detector tracks two-dimensional interest points over time rather than three-dimensional interest points in the x-y-t domain, by sampling and tracking feature points on a dense grid and extracting the dense trajectories. A DTF-MBH feature detector applies the MBH descriptors to the dense trajectories to capture object motion information. The MBH descriptors represent the gradient of optical flow rather than the optical flow itself. Thus, the MBH descriptors can suppress the effects of camera motion, as well. However, HoF (histograms of optical flow) may be used, alternatively or in addition, in some embodiments.

Feature extractor 212 can quantize extracted low-level features by feature type using a feature-specific vocabulary. In some embodiments, the feature-specific vocabulary or portions thereof are machine-learned using, e.g., k-means clustering techniques. The quantized low-level features may be aggregated by feature type, by using, for example, a Bag of-Words (BoW) model in which a frequency histogram of visual words is computed over the entire game video. The BoW model may correspond to a specific video game, a video game type, various combinations of video games or all video games.

In some embodiments, feature extractor 212 may extract and analyze additional features from the game video by interfacing with an automated speech recognition (ASR) component and/or an optical character recognition (OCR) component. Feature extractor 212 can interface with an ASR component to identify spoken words in the audio track of the game video. Feature extractor 212 can interface with an OCR module to recognize text present in a visual scene of the game video.

Concept detector 214 is configured to detect video game concepts for a video game based on the extracted low-level features and knowledge of spatial/temporal relationships of the video game. Concept detector 214 can include one or more concept classifiers trained by machine learning to detect game concepts based on the ontology and taxonomy of a video game. Machine learning can include retrieving and applying established relationships between multiple low-level features and game concepts. For example, a concept classifier can ingest low-level features extracted from a segment of a game video. The concept classifier can apply its concept detection algorithm to those extracted low-level features. The concept classifier can provide a detection confidence value indicating the likelihood that the corresponding video segment depicts the concept that the classifier has been trained and designed to detect.

For concept classifiers that detect actions, input may be a short segment of the video. For concept classifiers that detect scenes, objects, or characters, input may be a key frame or a series of key frames sampled from the video. As complex events may include multiple concepts depicted in the same key frames or video segments, multiple different types of concept classifiers may be applied to the same game video input to detect different concepts.

In some embodiments, concept classifiers, implemented as Support Vector Machine (SVM) classifiers, can be applied directly to the BoW features. Data fusion strategies (e.g., early and late fusion) can identify and extract complex events based on fused low-level features. In other embodiments, intermediate concept detection is based on the low-level features, and then higher-level complex events are determined based on the detected concepts.

In one aspect, a type creator is configured to create a sematic concept space for various detected concept types. Within a semantic concept space, concept types can be represented as vectors. The vectors can include a number of dimensions each representing a pre-defined concept, and more particularly a type of (e.g., complex) event of interest that may occur in the game video (e.g., a fight, a chase, a group celebration, etc.). The concept classifiers essentially populate each dimension of the vector with a data value indicating presence or absence of the corresponding event of interest in a given excerpt of game video. Thus, the detected game concepts form a time series within a concept space for the video game. Accordingly, concept classifiers can analyze any of spatial, temporal, and semantic relationships among concept types. Concept classifiers can also analyze extracted low-level features and detect instances of the concepts of interest within a higher-level concept space for each concept type.

In one aspect, concepts of higher interest (e.g., based on user preference) become concept types included in a concept space. Concepts of lower interest may not be included in the concept space.

Highlight generator 218 is configured to generate game highlights using at least a subset of game concepts from a concept space. Game concepts of higher interest are ranked higher than game concepts of lesser interest. Generation of a game highlight can be based on one or more of: rank, repetitiveness, visual impact, game knowledge, user preference, length, style, and other factors.

Highlight combiner 220 is configured to combine highlights into a highlight compilation. When appropriate, highlight combiner 220 can fuse together video segments corresponding to game highlights, with special effects if desired, to form a compilation of game highlights for a user.

A highlight or a compilation of multiple highlights, can be stored in storage 231. In one aspect, detected concepts are also stored in storage 231.

A highlight or a compilation of multiple highlights can also be provided to a user for verification upon request. The highlight(s) can be used for sharing with others, such as, for example, via social media sites, websites, video sharing sites, game promotion sites, or elsewhere. In another aspect, a user can, if desired, edit each of the highlights based on detected game concepts.

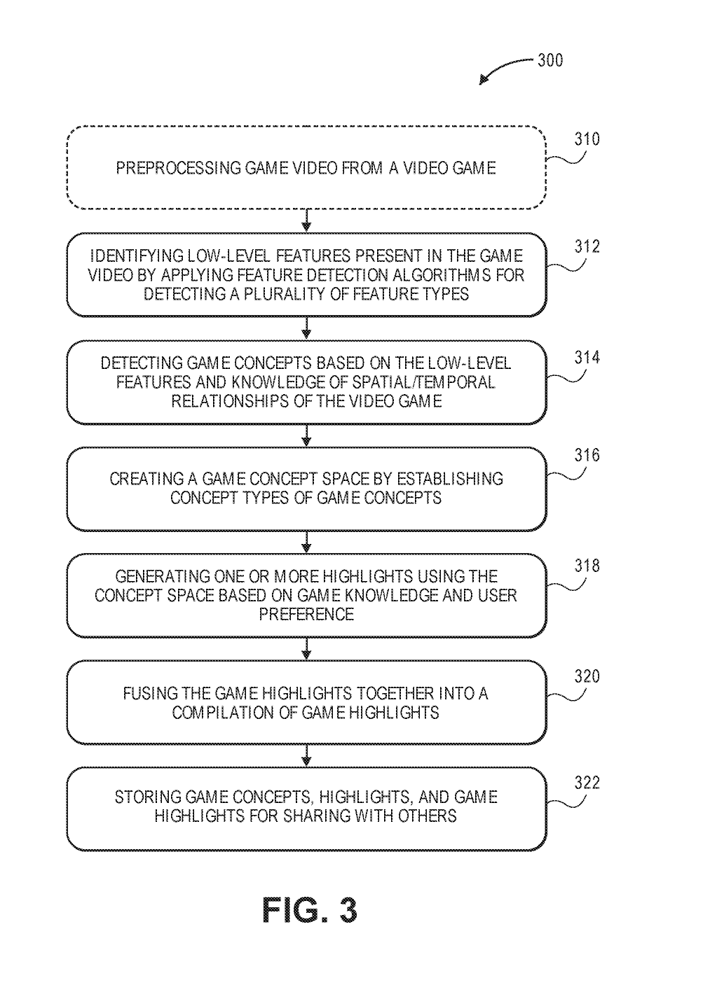

FIG. 3 illustrates a flow chart of an example method 300 for identifying and extracting video game highlights. The method 300 will be described with respect to the components and data of computer architecture 200.

Computer system 201 can access game video 222. Game video 222 can be a recording of game activity from a video game. Alternately, game video 222 can be game activity from a video game that is being streamed to computer system 201.

Method 300 includes optionally preprocessing game video from a video game (310). For example, video preprocessor 210 can preprocess game video 222. Game video 222 may be in a form that is not compatible one or more of: feature extractor 212, concept detector 214, highlight generator 218, or highlight combiner 220. When game video 222 is in a form that is not compatible, video preprocessor 210 can perform one or more of: decompressing game video 222, enhancing the video quality of game video 222, computing shots and cut scenes for game video 222, or extracting key frames from game video 222. Video preprocessor 210 can output game video 222P that is compatible with feature extractor 212, concept detector 214, highlight generator 218, and highlight combiner 220.

As such, when game video 222 is compatible with feature extractor 212, concept detector 215, highlight generator 218, or highlight combiner 220, game video 222 can be sent initially to feature extractor 212. When game video 222 is not compatible with feature extractor 212, concept detector 214, highlight generator 218, or highlight combiner 220, game video 222 can be sent initially to video preprocessor 210. Video preprocessor 210 can generate game video 222P that is then sent to feature extractor 212.

Method 300 includes identifying low-level features present in the game video by applying feature detection algorithms for detecting a plurality of feature types (312). For example, feature extractor 212 can apply feature detection algorithms to game video 222 or game video 222P to extract features 203. Method 300 includes detecting game concepts based on low-level features and knowledge of spatial/temporal relationships of the video game (314). For example, concept detector 214 can detect concepts 204 based on features 203 and knowledge of spatial/temporal/semantic relationships from the video game where game video 222 was recorded (or the video game that is streaming game video 222).

Method 300 includes creating a game concept space by establishing concept types of game concepts (316). For example, concept detector 214 can create concept space 206 from concepts 204. Concept space 206 includes different concept types, including concept type 208A, concept type 208B, etc. Method 300 includes generating one or more highlights using the concept space based on game knowledge and user preference (318). For example, highlight generator 218 can generate highlights 209 using concept space 206 based on game knowledge 221 (from the video game where game video 222 was recorded or is being streamed from) and user preference 224.

Method 300 includes optionally fusing the game highlights together into compilation of game highlights (320). For example, highlight combiner 220 can fuse highlights 209 together into highlight compilation 223.

Method 300 includes storing game concepts and highlights for sharing with others (322). For example, highlight generator 218 can store highlights 208 at storage 231. Likewise, highlight combiner 220 can store highlight compilation 223 at storage 231. Similarly, concept detector 214 can store concepts 204 at storage 231.

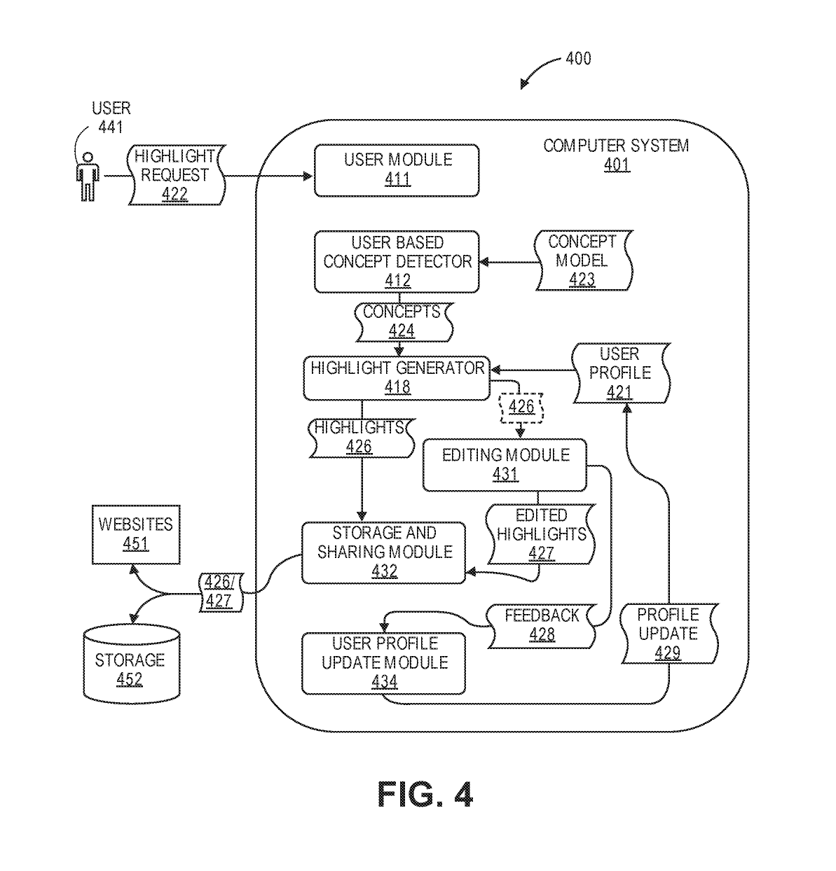

FIG. 4 illustrates an example computer architecture 400 that facilitates identifying and extracting video game highlights. As depicted, computer architecture 400 includes computer system 401. Generally, computer system 401 can include modules that, using a processor (e.g., processor 102), process game video into one or more highlights. In one aspect, game video is accessed from a storage device, such as, hard disk drive 124 or removable storage 126. A user may request highlights through an I/O device (e.g., from among I/O devices 110). In response, the modules of computer system 401 access game video form the storage device. The modules of computer system 401 process the accessed game video to identify and extract one or more highlights from the game video.

More specifically, as depicted in computer architecture 400, computer system 401 includes user module 411, use based concept detector 412, highlight generator 418, editing module 431, sharing module 432, and user update 434.

User module 411 is configured to receive user requests for game video highlights. User module 411 is also configured to determine if a user requesting game video highlights is an existing (e.g., prior) user or new user. When a user is an existing user, user module 411 can refer to a profile for the user. If the user is new and does not have a profile, user module 410 can create a profile for the user. Profile creation can include taking input from the user.

User based concept detector 412 is configured search a game concept space for concepts of importance to a user. Important concepts may be pre-configured, for example, as part of a game highlighting system (e.g., similar to computer architecture 200) or selected by the user.

Highlight generator 418 is configured to generate highlights from game video. When a user has a profile, highlight generator 418 can generate highlights based on contents of the profile.

Editing module 431 is configured to provide an interface for editing a generated highlight. A user may choose to edit a highlight to make the highlight more to their liking or tastes.

Storage/Sharing module 432 is configured to storage a highlight and/or share a highlight with other users. Storage can be in a local or remote storage location. Sharing can be through direct electronic communication (e.g., email or text), through postings on social media sites, through postings on video sharing sites, etc.

User profile update module 434 is configured to modify user profiles. User profile update module 434 can modify a user profile based on the changes selected by a user during the highlight editing process.

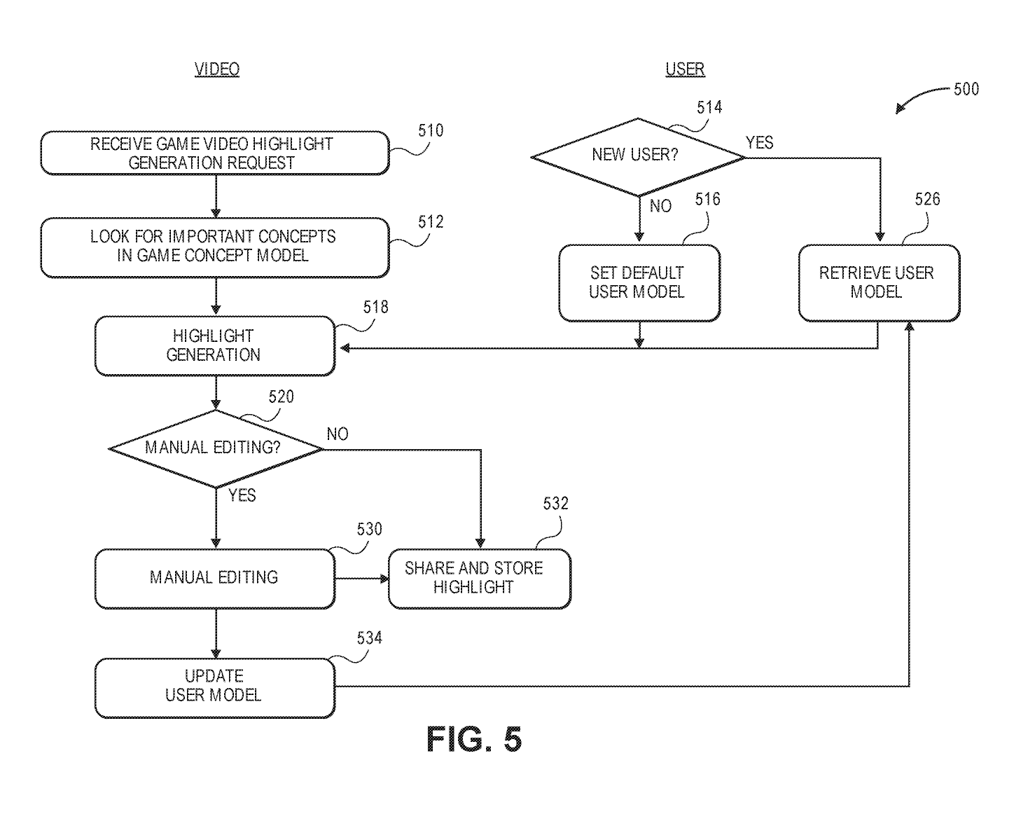

FIG. 5 illustrates a flow chart of an example method 500 for identifying and extracting video game highlights. The method 500 will be described with respect to the components and data of computer architecture 400.

Method 500 includes receiving a game video highlight generation request (510). For example, user module 411 can receive highlight request 422 from user 441. Highlight request 422 can be a request for highlights from a game video that was recorded within a video game.

Method 500 includes looking for important concepts in a game concept model (512). For example, in response to highlight request 422, user based concept detector 412 can look for concepts 424 in concept model 423. Concepts 424 can be concepts from concept model 423 that are of importance to user 441. Concepts 424 may be pre-configured, for example, as part of a game highlighting system or selected by user 441. User based concept detector 412 sends concepts 424 to highlight generator 418. Highlight generator 418 receives concepts 424 from user based concept detector.

Method 500 includes determining if a user is a new user (decision block 514). For example, highlight generator can determine if user 441 is a new user. If user 441 is a new user (YES at decision block 514), method 500 transitions to setting a default user model (514). For example, computer system 401 can set a default user model for user 441.

On other the hand, if user 441 is not a new user (NO at decision block 514), method 500 transitions to retrieving a user model for the user (526). For example, computer system 401 can retrieve a (e.g., previously configured) user model for user 441.

Method 500 includes generating highlights (518). For example, highlight generator 418 can retrieve preferences for particular concepts of interest from user profile 421. Highlight generator 418 generates highlights 426 for the game video using concepts 424 based on preferences from user profile 421.

Method 500 includes determining if a user is to manually edit highlights (decision block 520). If the user desired to manual edit (YES at decision block 520), method 500 transitions to manually editing the highlights (530). For example, highlight generator 418 can send highlights 426 to editing module 431. User 441 can interact with editing module 431 to edit highlights 426 into edited highlights 427. When editing is completed, method 500 includes sharing and/or storing highlights (532). For example, editing module 431 can send edited highlights 427 to storage and sharing module 432.

On the other hand, if user desires not to manually edit (NO at decision block 520), method 500 transitions to sharing and/or storing highlights (532). For example, highlight generator 418 can send highlights 426 to storage and sharing module 432.

Storage and sharing module 532 can share highlights 426 and/or edited highlights 427 at websites 451. Alternately or in combination, storage and sharing module 532 can store highlights 426 and/or edited highlights 427 at storage 452.

Method 500 also includes updating a user model (534). For example, after editing highlights 426 into edited highlights 427 is complete, editing module 431 can provide feedback 428 to user update module 434. User update module 434 can use feedback 428 to derive profile update 429. User update module 434 can use profile update 429 to update user profile 421. User profile 421 is updated so that next time highlight generator 418 generates highlights for user 441 the highlights are more similar to edited highlights 427. Accordingly, based on feedback and/or manually-generated highlights, preferred game concepts and highlight styles of individual users can be learned.

To increase understanding of game video and extract highlights, context within game ontology can be recognized. For example, if it can be detected where the activity captured in a video frame/segment is located with respect to the entire play field, visual features-based matching can be used to detect and recognize the scene with respect to its location on the play field, thereby providing context for game video understanding. When a game map is available for the video game, the map can be used to detect the location of the scene. A video game map in spectator mode can also be used to detect the locations of game characters, the configuration and distribution of the characters, and the location of the current view captured in a given frame/segment in order to classify the current scene based on game ontology.

It is also possible to anticipate a region of interest in a game video that likely contains a highlight (such as a team fight) based on results of scene detection. The map may also identify geographical obstacles that define the boundaries of areas of interest. Detection algorithms can be used to detect weapons and to detect characters. Activity detectors can detect activities, such as, walking, running, jumping, hitting, and other moves. A complex event may identify highlights, wherein the event is based on a combination of low-level features that include, for example, objects, faces, a scene, and activities. The location of one or more game characters at a map location can indicate a complex event having activity and may be used to identify a highlight of interest and to provide context for complex event analysis. The system can build activity models and activity transition models to anticipate future highlight.

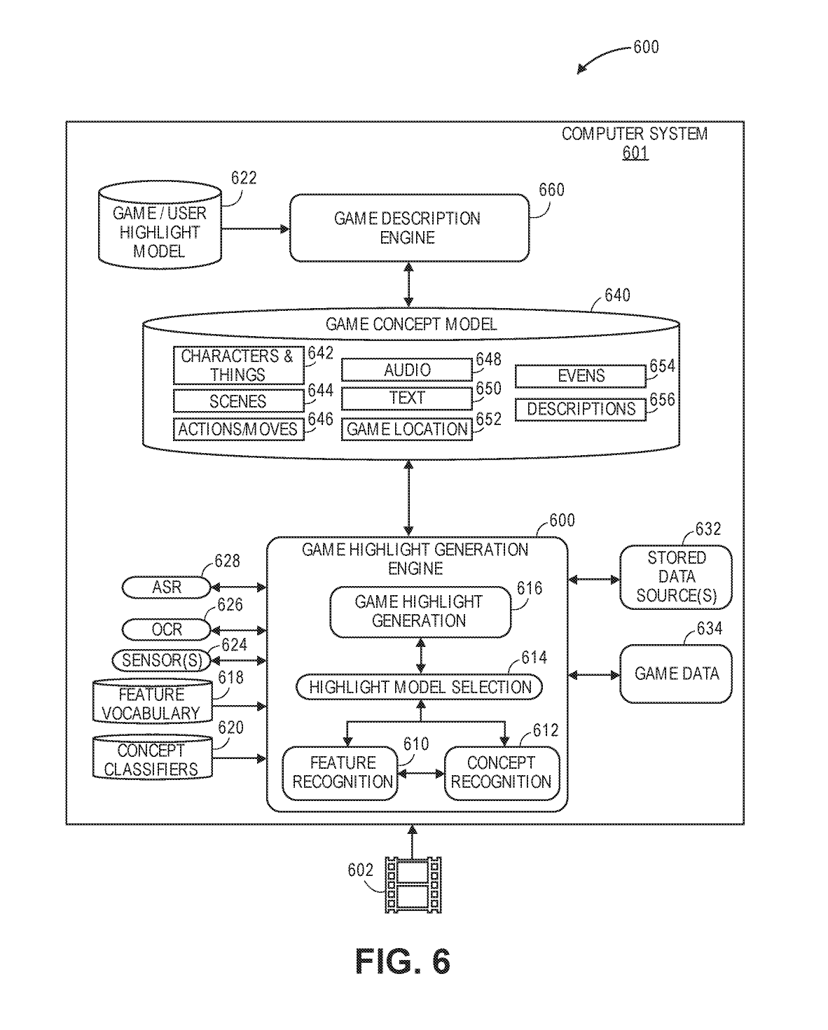

Referring now to FIG. 6, FIG. 6 illustrates an exemplary computer architecture 600 that facilitates creating video game highlights based on concept ontology. As depicted, computer architecture 600 includes computer system 601. Generally, computer system 601 can include modules that, using a processor (e.g., processor 102), process game video into one or more highlights. In one aspect, game video is accessed from a storage device, such as, hard disk drive 124 or removable storage 126. A user may request highlights through an I/O device (e.g., from among I/O devices 110). In response, the modules of computer system 601 access game video form the storage device. The modules of computer system 601 process the accessed game video to identify and extract one or more highlights from the game video.

As depicted, computer system 601 includes game description engine 660. Game description engine 660 generates semantic descriptions (e.g., natural language tags) for a game highlight. To do this, the game description engine 660 utilizes a game/user highlight model 622 and a game concept model 640. The models 622, 640 may be implemented as, for example, a searchable database or knowledge base, or other suitable data structure. The game/user highlight model 622 can include user-preferred descriptions for various game concepts, such as character names and shorthand expressions for game actions. The game concept model 640 can be preconfigured, e.g., by the developer of the video game with semantic descriptions for characters and things 642, scenes 644, actions/moves 646, audio 648, text 650, game location 652, events 654, and other descriptions 656. The game concept model 640 may be implemented as, for example, a hierarchical ontology.

A game highlight generation engine 670 interfaces with the game concept model 640 to update the game concept model 640 to include information relating to detected highlights and/or based on the user model 622. The illustrative game highlight generation engine 670 includes a game highlight generation module 616. Game highlight generation module 616 can generate game highlights using techniques described with respect to computer architectures 200 and 400 as well as other described techniques.

Game highlight generation module 616 interfaces with a highlight model selection module 614, in order to apply the feature recognition components 610 (e.g., low level feature detectors) and concept recognition components 612 (e.g., concept detectors) to the game video 602 being analyzed. To generate game highlights, game highlight generation engine 670 or one or more of its subcomponents may access data from a number of different sources, including output of an ASR system 628 (e.g., text of words spoken by characters or commentator during playing of the game); output of an OCR system 626 (e.g., text present on a visual feature); sensor output 624 (e.g., real time geographic location information, motion data, etc.); a feature vocabulary 618, concept classifiers 620, and stored data sources 632 (which may include Internet-accessible data sources such as Wikipedia, etc.).

The highlight generation technology described above can be enhanced with the use of game data (e.g., meta data supplied by the game manufacturer). In these embodiments, as shown in FIG. 6, game data 634 is another input to the game highlight generation engine 670, which can be used to identify the game highlights

For example, game data may show or otherwise indicate the location of different characters and their locations in the play field, and this location data can be used directly in the detection of game activities and events, such as a team fight or a specific character fighting another specific character of interest. The game data can also be used by the system to help identify highlight events of interest directly, for example in cases where the game data includes messages such as “double kill” or “shut down” in the game League of Legends.

The foregoing description has been presented for the purposes of illustration and description. It is not intended to be exhaustive or to limit the invention to the precise form disclosed. Many modifications and variations are possible in light of the above teaching. Further, it should be noted that any or all of the aforementioned alternate embodiments may be used in any combination desired to form additional hybrid embodiments of the invention.

Further, although specific embodiments of the invention have been described and illustrated, the invention is not to be limited to the specific forms or arrangements of parts so described and illustrated. The scope of the invention is to be defined by the claims appended hereto, any future claims submitted here and in different applications, and their equivalents.

What is claimed:

1. A method for generating highlights from a game video of a video game, the method comprising:
identifying low-level features present in the game video by applying feature detection algorithms for detecting multiple feature types, wherein the feature types include at least one of scenes, characters, actions, objects, texts, audio, items defined by the video game, and descriptions;
detecting game concepts based on the low-level features and knowledge of one or more of characteristics of the video game, each of the one or more characteristics selected from among: a relationship, a feature, or a concept of the video game, each of the one or more characteristics selected from among: a spatial characteristic, a temporal characteristic, or a semantic characteristic of the video game;
creating a game concept space by establishing concept types of game concepts of high interest; and
generating one or more highlights based on concepts detected in the game video and user preference.

2. The method of claim 1, wherein detecting game concepts is further based on machine learning that has established relationships between one or more of: (a) low-level features and game concepts and (b) games concepts and game highlights.

3. The method of claim 1, further comprising fusing highlights from one or more concepts appropriately relevant to the game type to form a game highlight.

4. The method of claim 1, further comprising pre-processing the game video.

5. The method of claim 1, wherein the algorithms for detecting multiple features include at least one of: a static visual feature detector and a dynamic feature detector.

6. The method of claim 5, wherein the static visual feature detector comprises a scale-invariant feature transform.

7. The method of claim 5, wherein the dynamic feature detector comprises a dense-trajectory based motion boundary histogram,

8. The method of claim 1, wherein concepts are tagged with a game-specific vocabulary.

9. The method of claim 8, wherein portions of the game-specific vocabulary are machine-learned.

10. The method of claim 1, comprising generating one or more highlights based on a user profile for a user that requested video highlights.

11. The method of claim 1, comprising generating one or more highlights based on metadata provided by the manufacturer of the video game.

12. A system for generating highlights from a game video of a video game, the system comprising:
one or more processors;
system memory; and
a game highlight generation engine, using the one or more processors, configured to:
identify low-level features present in the game video by applying feature detection algorithms for detecting multiple feature types;
detect game concepts based on the low-level features and knowledge of spatial/temporal relationships of the video game;
create a game concept space by establishing concept types of game concepts of high interest; and
generate one or more highlights based on concept types and user preference.

13. The system of claim 12, wherein the feature types include at least one of scenes, characters, actions, objects, texts, audio, items defined by the video game.

14. The system of claim 12, configured to detect game concepts based on machine learning that has established relationships between low-level features and game concepts.

15. The system of claim 12, configured to tag concepts with a feature-specific vocabulary.

16. The system of claim 12, wherein portions of the feature-specific vocabulary are machine-learned.

17. The system of claim 12, wherein the game highlight generation engine, using the one or more processors, is configured to generate one or more highlights based on metadata provided by the manufacturer of the video game.
